(19) United States
(12) Patent Application Publication
(10) Pub. No.: US 2011/0295660 A1
(43) Pub. Date: Dec. 1, 2011

(54) METHOD FOR PROCESSING MOBILE ADVERTISEMENT

(75) Inventor: Ju Heon Lee, Suwon (KR)

(73) Assignee: CoSTEP Co., Ltd., Gasan-Dong (KR)

(21) Appl. No.: 12/913,074

(22) Filed: Oct. 27, 2010

(30) Foreign Application Priority Data
Jun. 1, 2010 (KR) 2010-0051984

(51) Int. Cl. G06Q 30/00

(52) U.S. Cl. 705/14.4

(57) ABSTRACT

Disclosed herein is a mobile advertisement processing method. The method is performed by a mobile terminal and an advertisement server connected over a network to an application server for providing an application. An advertisement to be exposed on the application and an advertisement completion condition are set. Advertisement data to be played on the application is provided in response to a request of the application run in the mobile terminal. Notification of whether the user has recognized the advertisement is received through the application, and exposures of the advertisement are totalized.

Accordingly, the present invention prevents users from getting tired with application-based mobile advertisements, and allows the users to positively respond to mobile advertisements, thus improving advertising effects.

### CROSS-REFERENCE TO RELATED APPLICATION

This application claims under 35 U.S.C. §119(a) the benefit of Korean Application No. 10-2010-0051984 filed Jun. 1, 2010, the entire contents of which are incorporated herein by reference.

### BACKGROUND OF THE INVENTION

1. Field of the Invention

The present invention relates, in general, to a mobile advertisement processing method, and, more particularly, to a mobile advertisement processing method, which conditionally deactivates an advertisement included in an application, thus grasping the advertising effects of the advertisement exposed by the application while improving the convenience of users.

2. Description of the Related Art

To date, the mainstream of mobile advertising market for mobile terminals has been realized by sending Short Message Service (SMS) messages from a mobile communication company to the mobile terminals of users. However, the mainstream of mobile advertising market is currently moving away from the sending of SMS messages towards the use of applications following the introduction of the iPhone.

Typically, the applications that run in mobile terminals are provided by manufacturing companies which manufacture the mobile terminals or mobile communication companies, and do not include advertisements. Currently, the iPhone provides various free applications to users, but exposes advertisements to the screens thereof whenever the applications are run, to make up for providing the applications for free. Accordingly, business models for creating advertising revenue rather than selling applications have increased.

Application-based advertisements have been provided using methods of exposing an advertisement before an application is executed or displaying an advertisement on the execution screen of the application, and inducing users to view the advertisement and to go to a landing page. However, such an application-based advertising method is disadvantageous in that a user must be exposed to advertisements whenever executing an application installed on his or her mobile terminal, so that the user is easily tired with viewing the advertisements and is exposed to unlimitedly repetitive advertisements at the cost of the free use of applications.

When a user is fed up with advertisements exposed on a mobile terminal, there may frequently occur the case where he or she disregards such an advertisement that is exposed whenever executing an application, without greatly caring about the advertisement. This becomes a factor responsible for deteriorating advertising effects.

Moreover, from the standpoint of an advertiser paying advertising costs, advertising effects that are obtained by advertisements which do not attract the attention of users may be insignificant.

Therefore, methods of causing application-based advertisements to attract the attention of users without inconveniencing users must be provided. Schemes for creating more advertising revenue by way of these methods have been required.

### SUMMARY OF THE INVENTION

Accordingly, the present invention has been made keeping in mind the above problems occurring in the prior art, and an object of the present invention is to provide a mobile advertisement processing method, which induces users to take an interest in advertisements while maximizing the users' convenience.

Another object of the present invention is to provide a mobile advertisement processing method, which enables application-based mobile advertisements to improve the response to commodities associated with the mobile advertisements, and to induce users to purchase the commodities.

In order to accomplish the above objects, the present invention provides a mobile advertisement processing method, the method being performed by a mobile terminal and an advertisement server connected over a network to an application server for providing an application, comprising the steps of setting an advertisement to be exposed on the application and an advertisement completion condition, providing advertisement data to be played on the application in response to a request of the application run in the mobile terminal, and receiving notification of whether the user has recognized the advertisement through the application, and totalizing exposures of the advertisement.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a processing flow diagram showing a mobile advertisement processing system according to an embodiment of the present invention;

FIG. 2 is a conceptual diagram showing a procedure in which an advertiser negotiates with an advertisement server; and

FIGS. 3 to 6 are reference diagrams showing a method of exposing advertisements on a mobile terminal.

### DESCRIPTION OF THE PREFERRED EMBODIMENTS

Prior to the describing the present invention, some terms will be defined as follows. Mobile terminals refer to devices such as a mobile phone, a Personal Digital Assistant (PDA), a Portable Media Player (PMP), a smart phone, and other devices, each of which can be carried by a user and is provided with memory, a processor, a user input device (key/button), etc.

Application-based advertisements or mobile advertisements described in the present invention denote advertisements represented on a mobile terminal in the form of at least one of images, sound, text and vibrations. In the present invention, such ‘mobile advertisements’ may be exposed to users in the form of at least one of images, sound, text and vibrations when an application that can be installed in a mobile terminal is run on the mobile terminal.

An advertisement server described in the present invention can provide advertisement data to the application installed in the mobile terminal of the user and can update the advertisement data. The advertisement server can receive notification of whether the user has recognized a relevant advertisement from the application installed in the mobile terminal, and can count the number of exposures of the advertisement and can calculate the statistics related to the advertisement exposures on the basis of the results of the notification. Therefore, the advertisement server which will be described later in the present invention may be connected to the mobile terminal over one, or two or more of communication networks such as a wireless network, a wired network, an optical network, and other various types of communication networks.

The application server described in the present invention provides an application to the mobile terminal when the mobile terminal requests the downloading of the application from the application server. However, the application server provides an application that exposes advertisements on the mobile terminal. It is apparent that the application server may be connected to various communication networks, such as a wired network, a wireless network, an optical network, and other networks, and may directly perform data communication with the mobile terminal through a base station.

In the description of the present invention, if the mobile terminal, the advertisement server, and the application server are not especially defined in detail in the present specification, the above-described definition will be referred to.

Hereinafter, the present invention will be described in detail with reference to the drawings.

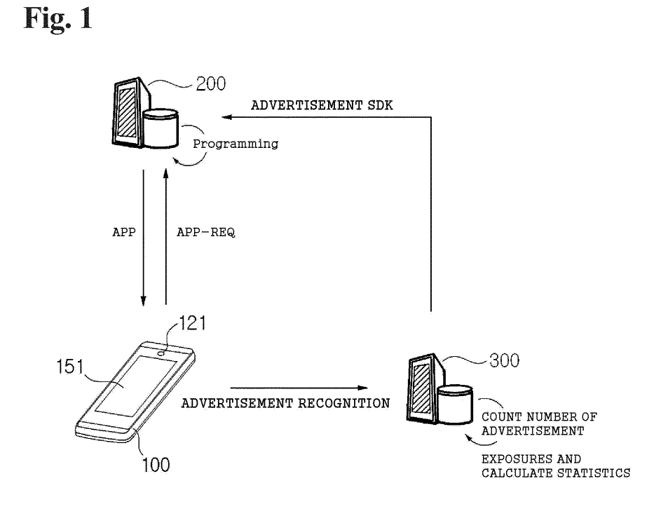

FIG. 1 is a flow diagram conceptually showing the advertisement processing of a mobile advertisement system according to an embodiment of the present invention.

Referring to FIG. 1, the mobile advertisement system using the mobile terminal according to the present invention may include a mobile terminal 100, an application server 200, and an advertisement server 300. The mobile terminal 100 accesses the application server 200 over one of wired and wireless networks and requests an application from the application server 200. The application server 200 provides an application for exposing advertisements to the mobile terminal 100. In this case, the application provided to the mobile terminal 100 may have one of the function of accessing the advertisement server 300 over a wireless network and notifying whether the user has recognized the advertisement, and the function of receiving advertisement data from the advertisement server 300 and updating the advertisement data.

The advertisement server 300 provides advertisement completion conditions, set by an advertiser or an application developer, to the mobile terminal 100. Further, when the application installed in the mobile terminal 100 notifies whether the user has recognized the advertisement, the advertisement server 300 can count the number of exposures of the advertisement and calculate advertising costs on the basis of the results of the notification.

In this case, the advertisement completion conditions set in the advertisement server 300 may include, for example, the following advertisement completion conditions including:
the condition in which a relevant advertisement is exposed to the mobile terminal 100 a predetermined number of times or more (for example, 10 times or more)
the condition in which a commodity corresponding to the advertisement is purchased using the mobile terminal 100
the condition in which the advertisement is played on the mobile terminal 100 a preset number of times
the condition in which the specific location of the advertisement is touched on the mobile terminal 100 a preset number of times
the condition in which a link included in the advertisement is accessed by the mobile terminal 100 a preset number of times

In this case, the term ‘the number of times’ in the advertisement completion conditions is called ‘exposure information’.

Further, the advertisement completion conditions proposed as examples in the above description may also be designated such that the advertisement is temporarily prohibited from being played during only a specific period. For example, it is possible to increase the convenience of the user tired with being exposed to the advertisements or effectively exhibit advertising effects in such a way that even when the condition in which a relevant advertisement is entirely deleted is that the advertisement has been exposed 10 times, if the advertisement has been exposed twice in a day, the advertisement is not played any more in that day, and is played again after 24 hours have passed. Even in this case, when the 10 exposures which correspond to the initial advertisement completion condition have been made, the advertisement is completely deleted. In this case, determination conditions designated to temporarily prohibit an advertisement from being played during a specific period, contrary to the advertisement completion conditions, are called ‘sub-advertisement completion conditions’. These sub-advertisement completion conditions include predetermined time information and sub-exposure information. Here, the number of exposures in the sub-exposure information is less than the number of exposures in the advertisement completion conditions in a logical aspect.

In the above description, the number of advertisement exposures is set as an example, and it is also possible to temporarily prohibit a relevant advertisement from being played during a specific period with regard to the number of touches or the number of plays by using the above method.

The advertisement completion condition in which a relevant advertisement is exposed to the mobile terminal 100 a predetermined number of times or more may additionally require a condition in which the user applies a touch input to the advertisement or in which the user respond to a specific image or text included in the advertisement so as to determine whether the user has been normally exposed to the advertisement.

The advertisement completion condition in which the commodity corresponding to a relevant advertisement is purchased by the mobile terminal 100 preferably includes a link or an address by which the user accesses an online shop so that the advertisement exposed to the mobile terminal 100 may induce the purchase of the corresponding commodity.

The advertisement completion condition in which a specific location on an advertisement is touched on the mobile terminal 100 is a method of notifying that the user has been desirably exposed to the advertisement. Such a touch location may be an area corresponding to the center or left/right and upper/lower edges of the advertisement, and the exposure location of a relevant advertisement may vary whenever the advertisement is exposed.

The advertisement completion condition in which the mobile terminal 100 accesses a link included in a relevant advertisement induces the user to actually purchase a commodity related to the advertisement, or allows the user to view the commodity even when he or she does not purchase the commodity. The above conditions may be set to be performed from 1 to n times.

The application server 200 includes a plurality of applications desired by users. An application developer programs the applications so that advertisement data is inserted into the applications provided by the advertisement server 300 or so that the applications can download and use advertisement data, by using an advertisement Software Development Kit (SDK).

When a relevant application is run in the mobile terminal 100, an advertisement may be played on a display unit 151 provided on the mobile terminal 100, or the advertisement completion conditions may be displayed on the display unit 151.

The application displays the number of times the remaining advertisements must be exposed to the user in the future after the relevant advertisement has been played, and the number of advertisements recognized by the user on the basis of the advertisement completion conditions, thus allowing the user to determine the number of remaining advertisements the user must recognize.

The application server 200 provides the application, developed by the application developer using the SDK acquired by the advertisement server 300, to the user's mobile terminal 100. In this case, the application developer sets an advertising area in the application using the advertisement SDK acquired from the advertisement server 300, and provides the resulting application to the application server 200. The advertising area corresponds to the advertisement and the area used to play the advertisement or display the advertisement completion conditions on the display unit 151 of the mobile terminal 100. The application server 200 may include at least one application programmed to set the advertising area or may generate an application, including an advertising area, using the advertisement SDK as needed.

The advertising area is the area in which the advertisement data provided by the advertisement server 300 is played. When a network access path for acquiring advertisement data is set up, the advertisement data may be acquired from the advertisement server 300 and may be displayed in the advertising area.

Alternatively, the advertisement data may be included in the application, and then the advertisement data included in the application may be played.

The application may be configured such that if an application provided by the application server 200 to the mobile terminal 100 is run, when an advertising area is assigned to the interface displayed on the display unit 151, the application wirelessly accesses the advertisement server 300 whenever it is run by the user, and requests and receives the advertisement data, and thereafter plays the advertisement data.

Alternatively, the application may be configured such that when basic advertisement data is stored in an application and the stored advertisement data is exposed or played a predetermined number of times, the application accesses the advertisement server 300, requests new advertisement data from the advertisement server 300, and then updates previous advertisement data.

The present invention does not separately limit the method in which the application directly plays advertisement data or a method in which the application receives advertisement data from the advertisement server 300 accessed over the network and plays the advertisement data.

Further, in the case where the application plays a plurality of advertisements, when the application is run in the mobile terminal 100, an advertising area is allocated to a portion of the interface displayed on the display unit 151 of the mobile terminal, and the plurality of advertisements may be sequentially played in the advertising area, or new advertisements updated by the advertisement server 300 may be exposed to the advertising area.

The application programmed using the advertisement SDK in the application server 200 may represent each advertisement through at least one of the display unit 151, a speaker 121, and an internal vibration module (not shown) whenever the application is run by the mobile terminal 100.

When the user carries out an advertisement completion condition agreed upon with the advertisement server 300 through the mobile terminal 100 or when an advertisement completion condition set as a default by the advertisement server 300 is carried out even if the user did not separately set the advertisement completion condition, the application does not expose the advertisement any more, and thereafter the user can use the application without being exposed to the advertisement.

Meanwhile, whenever an application programmed using the advertisement SDK is selected and run by the user, it provides its own information required for advertising to the advertisement server 300, and requests an advertisement from the advertisement server 300. In this case, the advertisement server 300 searches for recordings of the exposure of the advertisement or an advertisement suitable for the application installed in the mobile terminal 100 on the basis of the received application information, and transfers the recordings or the advertisement to the application.

Meanwhile, the application in which advertisement completion conditions are set may notify the advertisement server 300 whether a relevant advertisement has been exposed whenever the application is selected and run by the user. In this case, the advertisement server 300 may become aware of the advertisement completion conditions via the application installed in the mobile terminal 100. If it is determined that the advertisement completion conditions have not been satisfied, the advertisement server 300 may command the application to continuously expose the advertisement until the advertisement completion conditions have been satisfied.

Meanwhile, the application may notify the advertisement server 300 whether a relevant advertisement has been exposed whenever the user runs the application. The advertisement server 300 counts the number of exposures of the advertisement notified of by the application, and determines whether the count value satisfies the user-defined advertisement completion conditions. If it is determined that the count value does not satisfy the advertisement completion conditions, the advertisement server 300 commands the application to continuously expose the advertisement while performing wireless communication with the mobile terminal 100, or, alternatively, transmits advertisement data and exposes a relevant advertisement to the mobile terminal 100 until a message indicating that the advertisement completion conditions have been satisfied is received from the advertisement server 300.

If the number of exposures of the advertisement notified of by the application using the wireless communication function of the mobile terminal satisfies the advertisement completion conditions, the advertisement server 300 notifies that the advertisement completion conditions have been satisfied, and the application deactivates the function of the advertisement or deletes the advertisement function.

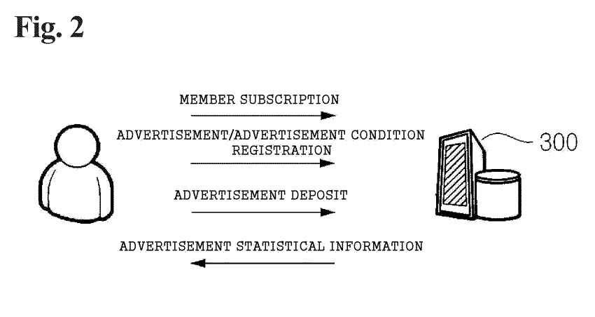

FIG. 2 is a conceptual diagram showing a procedure in which an advertiser negotiates with an advertisement server.

Referring to FIG. 2, the advertiser subscribes to the advertisement server 300 as a member, selects a desired advertisement condition, and sends an advertisement deposit to an account guided by the advertisement server 300 according to the selected advertisement condition. The advertisement condition desired by the advertiser may be, for example, the frequency or the number of times an advertisement is exposed on an application, expenses corresponding to the number of exposures, advertisement completion conditions, the type of advertisement, an application to be matched with the advertisement, etc. In this case, the advertiser may designate his or her advertisement to be exposed on a specific application. The advertisement server 300 sets an application to be matched with the advertisement of the advertiser according to the advertisement condition designated by the advertiser, and prepares the advertisement required when matching the advertisement data provided by the advertiser with the application. The generated advertisement may be displayed in a portion of the application which has been developed by an application developer using an SDK provided by the advertisement server 300.

In the application provided by the application server 200 to the user, an advertising area is set. In the advertising area, the advertisement data provided by the advertisement server 300 may be played. It is apparent that the basic advertisement of the advertiser is included in the application, and the advertisement server 300 can later update the advertisement data to be played in the advertising area.

The application may notify the advertisement server 300 whether the user has recognized the advertisement data played on the mobile terminal 100 whenever the user recognizes the advertisement data.

When the application notifies the advertisement server 300 whether the user has recognized a relevant advertisement, the advertisement server 300 counts the number of exposures of the advertisement on the application, determines whether the advertisement completion condition has been satisfied, and can command the application not to play the advertisement data any more in the advertising area if it is determined that the advertisement completion condition has been satisfied. On the other hand, it is also possible that the application checks the advertisement completion condition by itself, and determines whether to continuously play the advertisement or to stop playing the advertisement.

In this case, the method of determining whether an advertisement has been recognized by the user may be performed by determining whether a key input or a touch input has occurred on the mobile terminal 100 when the advertisement was being played.

Further, it is also possible to determine whether an advertisement has been recognized according to the type of advertisement.

For example, when the advertisement data is image-type data, such determination may be performed when a touch input or a key input is applied to the mobile terminal 100.

Alternatively, whether the user recognizes the advertisement can be determined by a touch input on a specific region of the played image, for example, a center portion of the image, edge portions of the image, or a specific icon indicated on the image.

When the advertisement data is video-type data, whether the user has recognized the advertisement can be determined by determining whether the video has been played for a preset period of time, or whether touch input was applied to an advertisement target included in the video.

Meanwhile, when the advertisement server 300 determines whether the user has recognized each advertisement, through the application, the mobile terminal 100 can totalize data indicating whether the advertisement was played according to the present condition, calculate the statistics related to each advertisement, and provide the calculated statistical information to the advertiser. In this case, the advertisement server 300 may provide the statistical information to an e-mail address registered by the advertiser, notify the advertiser of the statistical information using a phone number registered by the advertiser via ARS, or allocate a separate web space to the advertiser and display the statistical information in the allocated web space.

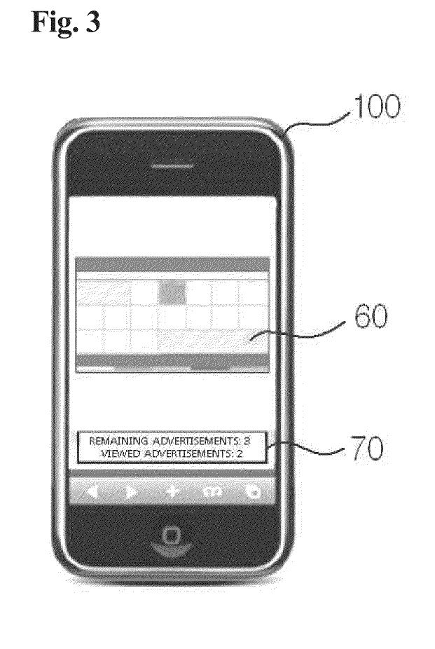

FIGS. 3 to 6 are reference diagrams showing methods in which advertisements are exposed to mobile terminals.

FIG. 3 illustrates the interface of an application run in the mobile terminal and an advertisement display interface.

Referring to FIG. 3, when a user runs an application installed in his or her mobile terminal 100, an interface 60 shown in the drawing is displayed on the screen of the mobile terminal 100. In a lower portion of the interface 60, an advertisement display interface 70 is additionally displayed. In the advertisement display interface 70, information indicative of ‘remaining advertisements: 3’ and ‘viewed advertisements: 2’ is displayed. The advertisement display interface 70 displays an advertisement completion condition provided by the advertisement server 300 on the mobile terminal 100. If the user does not set an advertisement completion condition separately from those provided by the advertisement server 300, the advertisement display interface 70 may display each advertisement completion condition set by the application server 200. Even in the case where the application server 200 has set an advertisement completion condition, remaining advertisements and viewed advertisements may be displayed in the form of FIG. 3. Methods of displaying an advertisement completion condition on the advertisement interface 70 may conform with a user-defined advertisement completion condition or an advertisement completion condition preset by the application server 200. These methods can be uniformly applied to the entirety of the present invention, as well as FIG. 3.

The advertisement completion condition of FIG. 3 indicates that the user received an application for free on condition that he or she views an advertisement five times, and it can be seen that two additional advertisement exposures are required for later.

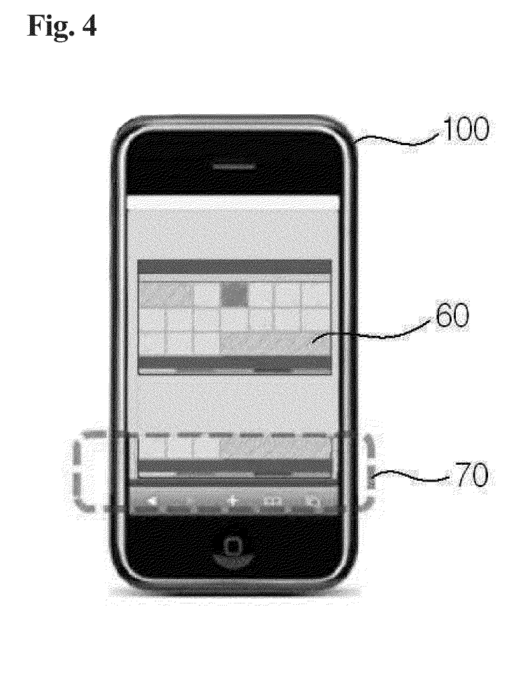

It is assumed that the advertisement completion condition is subject to the condition that a touch input be applied to the screen whenever an advertisement screen is displayed. In this case, when the user applies a touch input at each time when the user viewed advertisements five times, the interface 60 is switched to the form of FIG. 4. FIG. 4 shows the interface 60 of the application when the advertisement completion condition has been satisfied. It can be seen in FIG. 4 that information that was displayed in the advertisement display interface of FIG. 3, that is, ‘remaining advertisements: 3’ and ‘viewed advertisements: 2’ is not displayed. When the user has satisfied the advertisement completion condition, he or she may not be exposed to the advertisement whenever running the application.

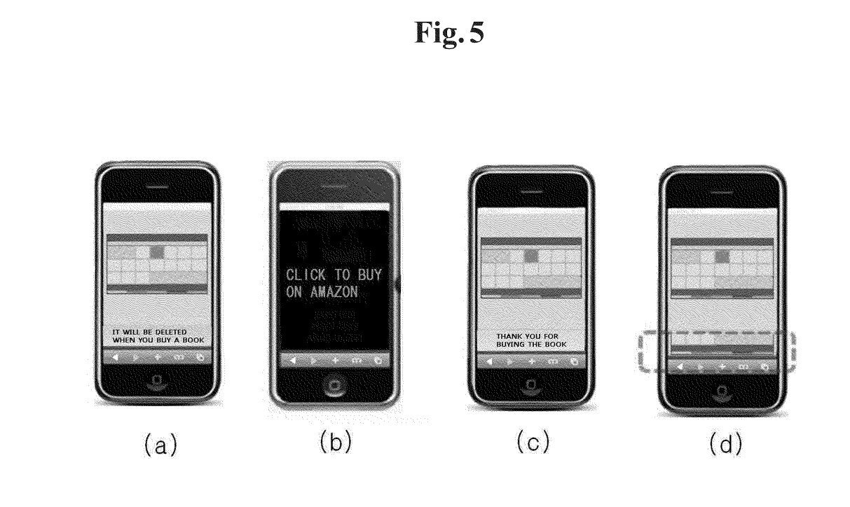

FIGS. 5A to 5D illustrate examples of an interface displayed on the screen of the mobile terminal 100 when an advertisement completion condition is “purchasing”.

Referring to FIG. 5A to 5D, FIG. 5A illustrates information (“deleted if a book is purchased”) displayed on the screen when an application is run according to the advertisement completion condition set in the application.

FIG. 5B illustrates an interface for applying to an online bookstore “Amazon” for the purchasing of a book.

FIG. 5C illustrates an interface displayed on the screen after a user purchases a book at Amazon.

FIG. 5D shows that after “purchasing”, which is the advertisement completion condition, has been satisfied, a phrase associated with advertisements disappears from the running screen of the application.

In FIG. 5A, when the user runs the application on the mobile terminal 100, the advertisement completion condition set in the application is displayed on the screen, thus inducing the user to purchase a commodity. In this case, in the interface displayed on the screen, a touch icon or a link for purchasing a relevant book may be displayed.

When the user accesses Amazon by selecting the touch icon or the link, and performs payment, the results of payment may be transmitted from Amazon to the advertisement server 300. Alternatively, the application may notify the advertisement server 300 whether payment has been performed.

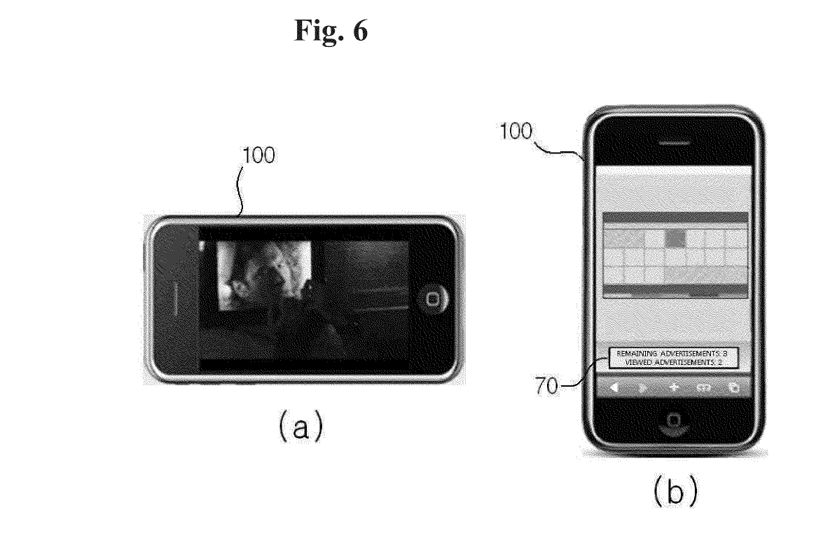

FIGS. 6A and 6B illustrate examples of an interface displayed on the screen of the mobile terminal 100 when an advertisement completion condition is “play”.

Referring to FIG. 6A, an advertisement video is being played on the screen of the mobile terminal 100, and the advertisement display interface 70 is displayed as shown in FIG. 6B whenever a user patiently views all of the advertisement videos, thus allowing the user to be aware of the number of times the remaining advertisements must be viewed. The user made an agreement to be exposed to the advertisement a predetermined number of times designated according to the advertisement completion condition, without being exposed to unrestricted advertisements. Accordingly, the user may patiently view video advertisements corresponding to the remaining number of times. In FIG. 6B, it can be seen that three remaining advertisements must be viewed, and that the advertisement display interface 70 is not displayed any more when the above condition has been satisfied.

As described above, the present invention is configured such that when an advertisement completion condition agreed with by the user to use an application for free is satisfied, the user is not exposed to additional advertisements.

The principle object of the present invention is to assign reasonability to advertisement exposures to the user and motivate the user to satisfy an advertisement completion condition in consideration of the fact that continuously and repeatedly exposing the user to undesirable advertisements is a factor responsible for decreasing adverting effects, thus inducing advertising effects on the contrary to be increased.

Further, the present invention maximally takes into consideration a user's desired advertisement method, thus minimizing a phenomenon in which the user hates and avoids advertisements having undesirable formats.

As described above, the present invention prevents users from getting tired with application-based mobile advertisements, and allows the users to positively respond to mobile advertisements, thus improving advertising effects.

Further, the present invention induces users to faithfully respond to advertisements, thus maximizing advertising effects desired by an advertiser.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mobile advertisement processing method, the method being performed by a mobile terminal and an advertisement server connected over a network to an application server for providing an application, comprising the steps of:
setting an advertisement to be exposed on the application and an advertisement completion condition;
providing advertisement data to be played on the application in response to a request of the application run in the mobile terminal; and
receiving notification of whether the user has recognized the advertisement through the application, and totalizing exposures of the advertisement,
wherein the advertisement server further comprises the step of acquiring information about the exposures of the advertisement from the application installed in the mobile terminal, and determines whether the acquired advertisement exposure information satisfies the advertisement completion condition.

2. The mobile advertisement processing method according to claim 1, wherein the advertisement server stops playing the advertisement on the application when the advertisement completion condition has been satisfied based on the advertisement exposure information.

3. The mobile advertisement processing method according to claim 1, wherein the advertisement completion condition is any one of a number of exposures of the advertisement, determination of whether to purchase a commodity associated with the advertisement, a number of times the advertisement has been played, determination of whether a user input has occurred when the advertisement is exposed, and determination of whether to access a link included in the advertisement.

4. The mobile advertisement processing method according to claim 3, wherein:
the advertisement completion condition comprises a sub-advertisement completion condition, and
the sub-advertisement completion condition comprises predetermined time information and sub-exposure information, and is configured such that if the sub-exposure information is satisfied even when the advertisement completion condition has not been satisfied, playing the advertisement is stopped during a predetermined period of time listed in the predetermined time information.

5. The mobile advertisement processing method according to claim 1, wherein the step of determining whether the advertisement has been recognized is configured to perform determination depending on whether an input corresponding to any one of a key input and a touch input to the mobile terminal has occurred.

6. The mobile advertisement processing method according to claim 1, wherein the application restricts exposure of the advertisement if the advertisement completion condition has been satisfied.

7. The mobile advertisement processing method according to claim 1, wherein the advertisement server comprises the steps of:
receiving notification of whether the advertisement has been exposed through the application;
comparing the number of exposures of the advertisement with the advertisement completion condition; and
determining based on results of the comparison whether to expose the advertisement.
